(19) United States
(12) Patent Application Publication
(10) Pub. No.: US 2007/0088939 A1
(43) Pub. Date: Apr. 19, 2007

(54) Automatic and dynamic loading of instruction set architecture extensions

(76) Inventors: Dan Baumberger, Cornelius, OR (US); Scott H. Robinson, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/252,393

(22) Filed: Oct. 17, 2005

(51) Int. Cl. G06F 9/00

(52) U.S. Cl. 712/248

(57) ABSTRACT

A portion of microcode for a processor is stored outside the processor. If needed for execution, the processor loads the microcode from outside the processor into a microcode storage inside the processor. The microcode is loaded in the form of a microcode patch which consists of the microcode as well as other optional metadata and configuration data. The processor stalls and saves all instruction state prior to loading the microcode. Thus, the processor does not need to store all of the microcode inside the processor. The size of the microcode storage on the processor may be reduced.

### BACKGROUND

1. Field of the Invention

Embodiments of the invention relate to instruction set architecture processors. Specifically, embodiments of the invention relate to automatic and dynamic loading of a microcode patch into a processor.

2. Background

A processor instruction set architecture (ISA) such as Intel® IA-32 describes the repertoire of instructions, also called macro-instructions, that a computer is designed to execute. Often processors implement the ISA (which includes the set of macro-instructions) using a combination of microcode and hardware. When an ISA is implemented on a single chip, a region of the chip is often dedicated to store microcode; that is, micro-instructions, also known as micro-operations or micro-ops, which the micro-architecture of a processor executes natively. Thus macro-instructions are decoded or translated into micro-instructions which implement the macro-instructions and control other aspects of processor operation (e.g. event delivery).

Microcode consists of fields specifying small operations, controls and data that the ISA (instructions and other event handling, etc.) can be decomposed into and which control the internal data and control paths of the processor microarchitecture. Microcode can be classified into numerous forms including “horizontal”, “vertical”, and “RISC-like” (Reduced Instruction Set Computer).

When the processor executes an ISA instruction (also herein referred to as a macro instruction), each such macro instruction is decoded into one or more micro-instructions called, herein, microcode flows. Some of the macro-instructions may be decoded into micro-instructions by decode logic (which may, for at least some embodiments, include programmable logic arrays). For other macro-instructions, the decode logic may instead map the macro-instruction onto a sequence of micro-operations implementing the macro-instruction. This can be done, for instance, by mapping the macro-instruction opcode and constituent fields into a starting microcode memory address for the microcode flow implementing that instruction. (For example, to read microcode out of an on-die microcode read-only memory (ROM)) Some processors employ hybrid systems where the first few micro-instructions of a microcode flow are emitted by the decoder directly. If there are more micro-instructions in the flow, the rest come from the microcode ROM. Some microcode flows may be strictly relegated to the microcode ROM. Many IA-32 Intel® processors work in these ways, for instance.

Regardless of the where the microinstructions are stored, any operands and required data are also passed (or inserted) into the microcode flow as parameters. In this way the high-level macro-code instructions (i.e. ISA instructions) of a computer program, e.g., an application or a control subroutine, are actually executed as micro-instructions (also called micro-operations).

Processors are often fabricated with the microcode hardwired into on-die Read-Only Memory (ROM) structures or other hardware lookup table mechanisms such as programmable logic arrays (PLAs). On-die microcode storage has many benefits including performance, ease of distribution and security. Conversely it means that the microcode in those on-die structures are relatively fixed. It also means that the processor die size increases with the amount of microcode it requires. As new features are provided to new generations of processors, more microcode is added to the on-die microcode storage to support these features. Thus, the size of the on-die microcode storage expands to accommodate the added microcode as well as legacy features from earlier generations. Some of the microcode supports features that are rarely used, and some is not performance-sensitive. Storing all of the microcode on a processor chip increases the size and cost of manufacturing newer generation processors, especially on single chip microprocessors. Even if on-die or on-package RAM is used to store microcode, it may have a limited size and is subject to similar cost and performance tradeoffs.

### BRIEF DESCRIPTION OF THE DRAWINGS

Embodiments of the invention are illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

FIG. 1 shows a system diagram of a computing system;

FIG. 2 shows a processor of the computing system;

FIG. 3 shows a flowchart for loading a microcode patch into the processor of the computing system.

### DETAILED DESCRIPTION

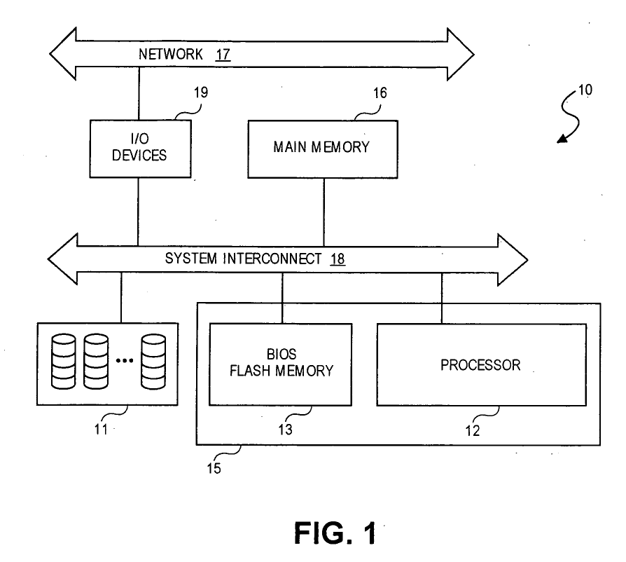

FIG. 1 illustrates an embodiment of a computing system 10 including a processor 12, main memory 16 and a plurality of I/O devices 19 coupled to a system interconnect 18 and a network 17 (e.g., local area network, wide area network, or the Internet). The computing system 10 may also include non-volatile memory or other machine-readable medium; for example, hard drive 11, a basic input/output system (BIOS) non-volatile memory (e.g., BIOS flash memory 13), and similar memory devices. The machine-readable medium includes any mechanism that provides (i.e., stores and/or transmits) information in a form readable by a machine (e.g., a computer). For example, a machine-readable medium includes read-only memory (ROM); random-access memory (RAM); magnetic disk storage media; optical storage media; flash memory devices; biological electrical, mechanical systems; electrical, optical, acoustical or other form of propagated signals (e.g., carrier waves, infrared signals, digital signals, etc.). The device or machine-readable medium may include a micro-electromechanical system (MEMS), nanotechnology devices, organic, holographic, solid-state memory device and/or a rotating magnetic or optical disk. The BIOS non-volatile memory stores BIOS code providing the lowest level interface to peripheral devices and may be located on a motherboard 15 with the processor 12. The main memory 16 may be Dynamic Random Access Memory (DRAM) or other machine-readable media. The main memory 16 may contain system programs, applications, and data. The processor 12 may be implemented on a single processor chip or package, or by multiple chips or packages. Thus, a feature or a component is said to be inside a processor if that feature or component resides in the processor chip(s) or processor package(s).

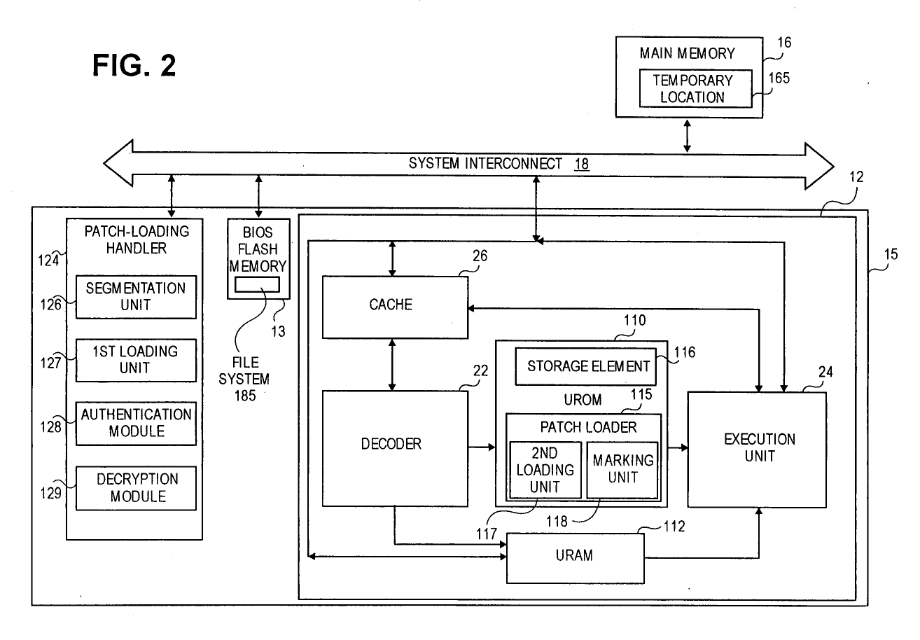

FIG. 2 shows an embodiment of the processor 12, in addition to some other components of the computer system 10 of FIG. 1. The processor 12 may include an instruction decoder 22 for mapping instructions (e.g., opcodes and operands) into micro-instructions, an execution unit 24 for executing the micro-instructions, and a cache 26 for storing pre-fetched instructions, data, and execution results. The execution unit 24 may include a plurality of pipelined units, each of which executes a modular portion of a micro-instruction in parallel to increase the efficiency of the processor. The processor 12 may also include Microcode Read-Only Memory (UROM) 110 for storing microcode (microcode, micro-operations and micro-instructions will be used interchangeably in the following discussion). The UROM 110 is coupled in between the decoder 22 and the execution unit 24. In one embodiment, the UROM 110 may contain a microcode-directed or micro-implemented patch loader 115 for handling the loading of a microcode patch. Microcode-directed means part of the implementation involves microcode. A microcode patch is a sequence of micro-instructions for correcting and implementing processor features.

The UROM 110 may have insufficient space for all the microcode available to the processor 12. Thus, part of the microcode may be stored in a file system 185 of a non-volatile memory, e.g., the BIOS flash 13, the operating system (OS) file system on the hard drive 11, or any machine-readable media locally accessible by software, e.g., BIOS, OS, virtual machine manager (VMM) via the system interconnect 18 or remotely accessible over the network 17. Accesses may require additional authentication, such as login identifications, tokens, tickets, passwords and/or other identifying information to be exchanged, etc. Although BIOS flash 13 is discussed below, it is understood that the microcode may be stored in any machine-readable media accessible by software. Embodiments described herein apply to all microcode types (e.g., horizontal, vertical or RISC-like micro-instructions).

It will be understood by those skilled in the art that design and implementation choices for how microcode is stored on and off chip will vary with technology, target markets, etc. Choices are driven by numerous factors such as die size, cost, access speed (latency and bandwidth), security, tamper resistance, persistence (volatility or non-volatility), memory size, power consumption, etc. Without loss of generality and by way of example, the description here focuses on the use of the UROM 110 for non-volatile, on-processor die microcode storage and a Microcode Random-Access Memory (URAM) 112 for on-processor die microcode patch storage. The UROM 110 and the URAM 112 are collectively referred to as the microcode memory. Other organizations and choices are possible, including the use of on-package and off-package microcode storage facilities. In an embodiment, microcode patches may be partially or fully unpacked to reduce the installation latency of that patch.

A microcode patch in the simplest form is an object containing microcode. Patches can include additional metadata such as the patch globally unique identifier (GUID), patch name and version information, cryptographic hashes or other checksum signatures, and patch functionality information. Microcode patches may be encrypted with secrets to prevent unauthorized tampering or Trojan horse attacks whereby the processor could execute errant or malicious microcode. Microcode patches may include initial value settings for other control states or registers on the processor 12 or platform (e.g., the system 10 of FIG. 1). These values may be set before the patch is loaded or after. Other processor or platform patches may be combined with the microcode patch so that a single, bundled object is delivered for consumption by the computer system 10.

It should be noted that other platform and ISA features or activities, not just instructions, are directed or implemented in microcode. The on-demand loading of patches for these features is accomplished in a similar manner as that described for instructions. A microcode patch may contain microcode implementing one or more processor or platform features. Microcode patches can provide new functionality, override old functionality, or augment existing functionality. For example, a microcode patch may provide a new processor instruction that computes Fibonacci numbers. Or, for instance, a patch may correct an error in the ADD macro instruction by overriding the existing microcode-directed ADD macro instruction with new microcode. If the existing microcode flow for the ADD instruction is in the UROM 110, then the processor 12 will contain hooks (e.g., implemented with pattern matching registers or content-addressable memories) in the decoder 22 for selecting the new microcode patch version of the ADD instruction over the original UROM-based microcode flow for the ADD instruction.

Traditionally microcode patches are installed during processor, BIOS, or operating system bootstrap or between software process switches. The microcode patches can be loaded into the processor 12 as needed. The retrieved microcode patches may be stored in machine-readable media such as the (URAM) 112 within the processor 12. The URAM 112 may receive microcode flows and microcode flow fragments/sections from software via microcode patches and deliver micro-instructions to the execution unit 24 for execution as fed by decoder 22. For a given instruction or set of instructions, the decoder, for example, selects the micro-instructions to execute from the UROM 110 and the URAM 112, possibly a combination thereof. In one embodiment, the URAM 112 may be a secured and protected area in which incoming microcode patches are authenticated and decrypted (e.g., by microcode) before acceptance for storage. In an alternative embodiment, the retrieved microcode patches may be stored in a secured portion of the main memory 16 in communication with the decoder 22 and the execution unit 24.

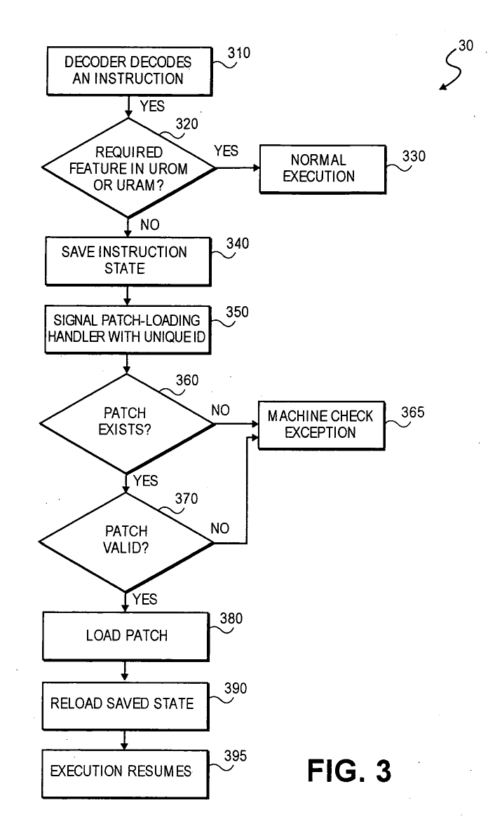

FIG. 2 further includes elements involved in a patch-loading process to be discussed below. FIG. 3 shows a flowchart 30 for dynamic, on-demand loading of a microcode patch from the BIOS flash 13 into the URAM 112. Although the BIOS flash 13 is used in the description, it should be understood that any machine-readable media outside the processor 12 may be used, whether locally or remotely accessible.

At block 310, during an instruction fetch, the processor's decoder 22 receives an instruction (e.g., a macro-instruction) stored in the cache 26 (or main memory 16) and decodes the instruction. The decoder 22 determines which micro-instructions implement the required feature (a.k.a. the required micro-instructions) for executing the instruction. In one embodiment, the decoder 22 may generate a microcode memory offset pointing to a location in the UROM 110 that contains the required micro-instructions or information that can be used to retrieve the required micro-instructions.

Flowchart 30 illustrates dynamic microcode patch loading for instructions. However, those skilled in the art will recognize that embodiments of this invention may be used to dynamically load microcode patches for other ISA or platform features that are implemented with microcode. In these cases other units constituting the processor 12 (other than the decoder 22) may be responsible for specifying the next micro-instructions (also herein referred to as microcode flows or microcode flow segments or subsequences) to execute. Thus, in an embodiment, for example, less frequently used branches of a given microcode flow may be loaded on demand and loaded as a patch into the URAM 112; whereas the most frequently executed portions of the flow are kept resident in the UROM 110 or the decoder 22.

At block 320, the processor 12 attempts to execute the required micro-instructions. The processor 12 first determines whether the required micro-instructions are present in the UROM 110, URAM 112 or in patch form outside the processor chip, e.g., in the BIOS flash 13. In one embodiment, the processor 12 detects the presence of the required micro-instructions by executing the code in a storage element 116 at the decoder-selected offset location of the UROM 110. If the required micro-instructions are stored in a patch form in the BIOS flash 13, the storage element 116 at the offset location contains information about the required micro-instructions instead of the complete micro-instruction flow. The information may be a short microcode flow for directing the operations of the processor 12 to request that software (e.g., BIOS or OS) load the required micro-instructions in the form of a microcode patch. The information may also include a unique identifier (ID) of the microcode patch. In an embodiment, the ID may be an integer. In an embodiment the integer may represent a patch sequence number or revision identifier, possibly compound, consisting of several major and minor revisions. In an embodiment, the integer may contain cryptographically encoded or compressed information.

Similarly, the micro-operations may come from the decoder 22 directly. In this case, the micro-operations can indicate that a dynamic patch load is required in the same manner as described above.

Alternatively, in an embodiment, the processor 12 detects the presence of the required micro-instructions using a portion of decoding logic during the decoding process. Using the decoding logic for this purpose may require a more complex decoder, but may further save the storage space in the UROM 110 for storing microcode flows.

At block 330, the processor 12 continues normal micro-instruction execution if the required micro-instructions are present in the UROM 110 at the offset location. Likewise, the processor 12 continues normal micro-instruction execution if the required micro-instructions (microcode flow) is found in the URAM 112. Otherwise, at block 340, a fault is generated to direct the processor 12 to save instruction state. When a fault occurs, the processor 12 stalls the current instruction and saves all the current state information. The saved information allows the processor 12 to resume execution from the same point when the fault occurs. An embodiment permits other microcode-directed ISA or platform features to be loaded on demand in a similar manner. In some cases it may be necessary for certain state to be either unwound back to a fault-like manner so that the operation can be restarted, or intermediate state information to be stored away for use by the dynamically loaded feature when it is loaded and resumes execution.

At block 350, the processor 12 generates a signal to a patch-loading handler 124. The signal conveys the ID of the microcode patch of the required features or notifies the patch-loading handler 124 to retrieve the microcode patch ID from some location (e.g., a general purpose register, a model specific register, memory location, etc.). The signal may be generated from any unit of the processor 12, e.g., the decoder 22, the execution unit 24, or any unit capable of generating the signals. The patch-loading handler 124 may be implemented in software as part of the OS, the BIOS, or the VMM. The patch-loading handler 124 may reside locally in the computing system 10 of FIG. 1 (e.g., the main memory 16 or BIOS flash memory 13). Alternatively, the patch-loading handler 124 may be implemented in hardware or firmware residing on the motherboard 15.

At block 360, the patch-loading handler 124 determines whether the patch ID corresponds to an existing patch in the BIOS flash 13. In an embodiment, this may entail determining if the patch has been segmented and/or pre-unpacked (e.g., separated from other microcode flow or patch file header information) and/or pre-authenticated and/or pre-decrypted in some alternate storage media to reduce overall patch load latency. In one scenario, the ID may correspond to a patch unavailable to the processor 12. A patch may be unavailable if the particular patch is not purchased for the system or if the patch is not yet installed in the BIOS flash 13 (or other available storage media). At block 365, if the patch does not exist in the BIOS flash 13, the patch-loading handler 124 generates a machine check exception or similar reporting mechanism which allows a handler to collect error information for debugging, logging, or remediation purposes.

If the patch exists in the BIOS flash 13, the patch-loading handler 124 may initiate a two-stage patch loading process. First, a first loading unit 127 of the patch-loading handler 124 loads the patch from the BIOS flash 13 into a temporary location accessible by the processor 23, e.g., temporary location 165 in the main memory 16. The patch-loading handler 124 then notifies the microcode patch loader 115 that the patch is ready. Upon receiving the notification, a second loading unit 117 of the patch loader 115 loads the patch from the main memory 16 into the URAM 112. In the embodiment described above, the patch loader 115 is implemented with microcode. In another embodiment, the patch loader 115 may be implemented with hardware by a unit outside of the UROM 110. During the first stage of patch loading, in one embodiment, a patch may be authenticated and decrypted before being loaded into the URAM 112. The patch-loading handler 124 may include an authentication module 128 and a decryption module 129 for authenticating and decrypting the patch. Authenticating and decrypting large patches may require a substantial length of time and processor resources. To accommodate larger patches and avoid violating the ability of the processor to respond to external world events (e.g., interrupts), the patch-loading handler 124 may include a segmentation unit 126 to segment a large patch into small portions. Thus, large patches may be authenticated, decrypted, and loaded in small portions to ensure timely opening of interrupt windows. If any of the patch portions does not pass authentication and decryption, the patch is considered invalid and a machine check exception occurs at block 365. Otherwise, when the last portion of a patch is authenticated, decrypted, and loaded into the URAM 112, a marking unit 118 of the patch loader 115 marks the patch “valid” or “active.”

In another embodiment, which has security advantages, microcode in the second loading unit 117 may contain and implement the authentication module 128, the decryption module 129, or both. The second loading unit 117 may also contain the segmentation unit 126.

In one embodiment, patches may be authenticated and decrypted into a secure memory before the patches are required for loading. For example, this memory may be on-package, but not on the processor chip itself. In this case, because of inter-chip communication distances it is still advantageous to load patches from this memory. Patch load times can be diminished because the patches are already authenticated and decrypted. Patches are then loaded from this secure memory into the URAM 112, on demand, as described by flowchart 30.

In one embodiment, for speed and security, patches are authenticated and decrypted into a portion of cache 26. This may require flushing that portion of cache 26. Once the patch is loaded out of the cache 26 into the URAM 112, the portion of the cache 26 used for patch authentication and decryption is scrubbed (e.g., written with zeroes) to prevent macro-instructions from accessing the contents of the patch.

During the second stage of the patch loading, in one embodiment, the patch-loading handler 124 saves the main memory 16 address of the patch into a register, e.g., a model-specific register (MSR). Thus, at block 380, the patch loader 115 reads the address from the MSR, retrieves the patch from the main memory 16, and loads the patch into the URAM 112.

After a microcode patch is loaded, the patch remains in the URAM 112 until the processor 12 is reset. The patch may be re-loaded after reset if an application requires the feature implemented in the patch. Thus, only the first time the feature is requested is there any delay. Unless the patch is evicted by another patch, subsequent usages of the feature do not incur any performance penalty.

In an embodiment, machine-readable media (e.g., the main memory 16) is used by the processor 12 to save the last patches loaded. In an embodiment, this is the entire patch. In another embodiment, the processor 12 saves the patch ID. During system boot strap, the processor 12 may consult this list of patches (or patch IDs) and proactively load the patches as they were needed last time the system was operational. The processor 12 can adopt one or more algorithms for managing a list of bootstrap-time patch loads to make. In another embodiment, patches may always be loaded on a demand basis only. In another embodiment, a flag may indicate whether a patch is to be dynamically loaded or whether the patch can be loaded at processor bootstrap time.

While the processor is running, a microcode patch may be evicted if the URAM 112 does not have enough space to accommodate all the patches loaded since the last processor reset. The processor 12 adopts one or more algorithms for managing the patch space in the URAM 112. For example, replacement algorithms like the least recently-used patch or the largest patch may get expunged, e.g., overwritten, when a new patch is loaded into the URAM 112. In one embodiment, identifiers, flags, or “colors” are used to mark various microcode flows and/or patches. Some identifiers indicate flows that are or are not evictable. Some identifiers indicate related flows which, if needed, the removal of one component should be accompanied by the other components with that shared identifier. Some microcode flows depend on one another, so if one flow is removed, the other flows can be removed as well.

After the patch is installed in the URAM 112, at block 390, the processor 12 re-loads the saved state for the instruction that was stalled. At block 395, the processor 12 resumes the execution of the instruction.

In one embodiment, multiple variations of a given patch are stored. These variations may represent different versions of a patch optimized in different ways such as to, for example, minimize the URAM 112 footprint size, minimize power consumption, maximize performance, etc. In an embodiment these patches may be computed for a class of anticipated uses, processors, platforms, software applications, etc. System software, or the processor 12, or microcode can determine which patch variant to load. This choice, for example, may be made based on metadata describing elements such as system/platform configuration and features (e.g., processor type), software configuration information, static system profiles, dynamic run-time profiling information (e.g., on-chip processor performance counters), etc. This information is conveyed during the patch load process described above in flowchart 30.

In the foregoing specification, the invention has been described with reference to specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense.

What is claimed is:

1. A method comprising:
attempting to execute microcode from a first machine-readable media inside a processor;
stalling the execution of the processor if the microcode is not present in the first machine-readable media; and
loading a patch containing the microcode from a second machine-readable media outside the processor onto the processor to continue the execution of the processor.

2. The method of claim 1 further comprising:
obtaining an unique identifier of the patch; and
signaling a patch-loading handler with the unique identifier to initiate a two-staged patch loading.

3. The method of claim 1 further comprising:
reading a metadata of each of a plurality variants of the patch; and
determining one of the variants to load into the processor based on information in the metadata.

4. The method of claim 1 further comprising:
recording information of a pre-determined number of the patches lastly loaded; and
loading the pre-determined number of the patches during system bootstrap.

5. The method of claim 1 further comprising:
authenticating and decrypting the patch before loading the patch.

6. The method of claim 1 further comprising:
loading the patch in small portions; and
marking the patch valid after the last portion is loaded.

7. The method of claim 1 wherein loading the micro-instructions comprises:
overwriting an existing patch inside the processor with the patch containing the microcode.

8. The method of claim 7 wherein overwriting the existing patch comprises:
removing from the first machine readable media other patches related to the patch being overwritten

9. An apparatus comprising:
a first machine-readable media inside a processor to store microcode and information of off-processor microcode, wherein the information of the off-processor microcode is to cause execution of the processor to stall if the processor attempts to execute the off-processor microcode from the first machine readable media; and
a patch loader to load a patch containing the off-processor microcode from a second machine-readable media outside the processor into the first machine-readable media to continue the execution of the processor.

10. The apparatus of claim 9 wherein the first machine-readable media further comprises:
platform features executable by the processor.

11. The apparatus of claim 9 further comprising:
a segmentation unit to segment the patch into portions, and
a marking unit to mark the patch valid after the last portion is loaded.

12. The apparatus of claim 9 further comprising:
a patch-loading handler to receive the unique identifier to initiate a two-staged patch loading.

13. The apparatus of claim 12 wherein the patch-loading handler comprises a first loading unit to load the off-processor microcode from the second machine readable media into a temporary location, and wherein the patch loader comprises a second loading unit to load the off-processor microcode from the temporary location into the first machine-readable media inside the processor.

14. The apparatus of claim 9 further comprising:
an authentication module to authenticate the patch; and
a decryption module to decrypt the patch.

15. A system comprising:
a first machine readable media outside a processor to store off-processor microcode;
a second machine-readable media inside the processor to store microcode and information of the off-processor microcode, wherein the information of the off-processor microcode is to cause execution of the processor to stall if the processor attempts to execute the off-processor microcode from the second machine-readable media; and
a patch loader to load a patch containing the off-processor microcode from the first machine readable media into the second machine-readable media to continue the execution of the processor.

16. The system of claim 15 wherein the second machine-readable media further comprises:
a storage element to store a unique identifier of the patch.

17. The system of claim 15 further comprising:
a segmentation unit to segment the patch into portions, and
a marking unit to mark the patch valid after the last portion is loaded.

18. The system of claim 15 further comprising:
a patch-loading handler to receive the unique identifier to initiate a two-staged patch loading.

19. The system of claim 18 wherein the patch-loading handler comprises a first loading unit to load the off-processor microcode from the first machine readable media into a temporary location, and wherein the patch loader comprises a second loading unit to load the off-processor microcode from the temporary location into the second machine-readable media inside the processor.

20. The system of claim 15 further comprising:
an authentication module to authenticate the patch; and
a decryption module to decrypt the patch.
